(19) United States
(12) Patent Application Publication
(10) Pub. No.: US 2019/0093777 A1
(43) Pub. Date: Mar. 28, 2019

(54) Water Heater Depleter

(71) Applicant: Jason Christopher Quan, Phoenix, AZ (US)

(72) Inventor: Jason Christopher Quan, Phoenix, AZ (US)

(73) Assignee: Water Heater Depleter, Phoenix, AZ (US)

(21) Appl. No.: 15/838,114

(22) Filed: Dec. 11, 2017

Related U.S. Application Data
(60) Provisional application No. 62/449,091, filed on Jan. 22, 2017.

(51) Int. Cl. F16K 17/168

(52) U.S. Cl. CPC F16K 17/168

(57) ABSTRACT

Fluid & Gas Purged & Injected Safely is a product that allows the end-user to either purge or inject fluids and gases into mechanical systems without exceeding the systems designed limits. The built-in adjustable pressure relief valve is set in the field by the user, or is factory set, to release excess pressure before it exceeds the engineered design. This safety precaution product prevents stresses on mechanical systems, which in many cases go unnoticed. System failures due to over pressurizing a system have caused serious injuries and deaths in the moment of the design breach and after the fact. In some cases: it can take years for a concealed section of a mechanical system to reveal there is a problem and by that time there are irreparable structural damages, adverse health issues, and in worse cases death. Safety by design sums up the nature of

[symbol]

The invention relates to the general field of purging or injecting fluids or gases contained in pipes, tubes, vessels, tanks, systems, and anything else that holds or conveys fluids or gases; and, has certain specific application to safely purging or injecting fluids in anything that holds or distributes fluids and gases in a closed or open loop environment.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### 1. Field of Invention

The present invention relates generally to introducing compressed air, needed fluids, or needed gases, into open or closed looped systems without exceeding the systems designed/engineered limits. An integral safety pressure relief valve limits the amount of pressure (PSI) that can be introduced into the system.

### 2. Description of the Related Art

Any discussion of the related art throughout the specification should in no way be considered as an admission that such related art is widely known or forms part of common general knowledge in the field.

Removing or injecting fluids and gases into or from mechanical systems with tubes, pipes, vessels, tanks, exchangers, and anything else that holds or carries fluids and gases in closed and open systems has been going on for years. To date the prior art has been to attach additional pipe or tube fittings to the system, and then connect an air hose or pump to those fittings. With this typical current practice, the PSI (Pound per Square Inch) entering the system is unregulated and, in many cases, exceeds the engineered/designed standards of the system.

Damages occur when a systems design is exceeded. To list all prior art that creates these possibilities would be too lengthy; so, these two examples are not meant to act in limiting the inventions usefulness against system damage, and more insight towards its usefulness will be in the proceeding claims.

First example: All plumbing codes limit the working pressure of a potable water distribution system to 80 psi. When removing potable water from a water distribution system, for various common reasons, one must not exceed 80 psi. When this type of system is pressurized beyond its designed working pressure: failures can either be immediate or discovered later. In most cases a failure is at a connecting joint. Sometimes a joint will blow apart completely; however, more often the joints will develop leaks. These leaks, whether large or small may not be detectable for some time and irreputable structural damages occur until they are discovered. Most of the time the damages reveal the leak—i.e. if a joint in a wall has a level of failure, then the damaged wall and flooring in the surround area is what reveals the problem. Furthermore, for this example, it is useful to note that the Temperature/Pressure Relief Valve on a hot water heater is set to open at 125 psi, 45 psi beyond plumbing statutes.

Second example: In a hydronic heating system where a boiler heats water for climate control purposes: these systems require two different related arts that show the usefulness of the invention. The first related art is air purging, and when performed at the highest level, it is done with the use of a fluid transfer pump. These pumps can exceed the designed working pressure of the systems pressure relief valve—30 psi. The usefulness of the invention in this case is to control where possible excess of pressure is released. There are adverse effects if the systems pressure relief valve opens and it would increase the scope of work considerably; so, this scenario is sought to be avoided. The second related art is that hydronic heating systems can be severely damaged if they fail to operate during freezing weather, and for this reason they add an antifreeze fluid to their closed loop systems. On hydronic heating systems that are installed in small commercial and residential environments: this antifreeze is introduced into the system via a fluid transfer pump. The same usefulness mentioned in the first action applies here in this second action; however, the first action is purging air, and the second action is injecting antifreeze.

While the prior art has served the mechanical industry for years, it has never served the safety of a mechanical system design. Systems have been damaged via the prior art, and this invention will secure a respect of design that hasn't been in the past. In other words: an adherence to the law that governed the design.

In these respects, the invention substantially departs from the conventional concepts and designs of the prior art, and in so doing provides an apparatus primarily developed for the purpose of maintaining an engineered designed limit. This invention will ensure no damage is done to a system.

### BRIEF SUMMARY OF THE INVENTION

In view of the foregoing disadvantages inherent in the known types of ways to purge or inject fluids and gases into a designed mechanical system present in the prior art, the present invention provides a new mechanical apparatus wherein the same can be utilized for adhering to the laws that governed the design of the system, which will prevent system damage.

The general purpose of the present invention, which will be described subsequently in greater detail, is to provide a purging/injecting mechanical apparatus that has many advantages over current purging/injecting mechanical apparatuses mentioned heretofore and many novel features that result in a new purging/injecting mechanical apparatus which is not anticipated, rendered obvious, suggested, or even implied by any combination thereof.

To attain this, the present invention generally comprises of a cast or machined body that connects to a mechanical system, a fluid or gas inlet/outlet, and a relief valve, that is calibrated for the application for which it is to be used.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a mechanical apparatus for purging and injecting fluids and gases in and out of designed mechanical systems without exceeding design standards of pressure, that will overcome the shortcomings of the prior art devices.

A second object of the present invention is to provide a purging/injecting mechanical apparatus that will increase the speed of purging and injecting fluids and gases in and out of designed mechanical system.

Another object of the present invention is to provide a purging/injecting mechanical apparatus that can be calibrated to a designed system working pressure.

A further object of the present invention is to provide a purging/injecting mechanical apparatus that can be calibrated to a designed system testing pressure.

Another object of the present invention is to provide a purging/injecting mechanical apparatus that can be calibrated to a desired pressure release.

An additional object of the present invention is to provide a purging/injecting mechanical apparatus that can have the pressure release in a remote location from where the purging/injecting is taking place.

Another object of the present invention is to provide a purging/injecting mechanical apparatus that addresses pressure concerns so that other objectives of the scope of work can be freely focused on.

Another object of the present invention is to provide a purging/injecting mechanical apparatus that keeps the work environment safer due to the absence of system design failures via over pressurization, that can spray fluids and gases in an uncontrolled fashion.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact; however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become better understood when considered in conjunction with the accompanying drawings, in which like reference characters designate the same or similar parts throughout the several views, and wherein:

FIG. 1 is an upper perspective view of the present invention.

FIG. 2 is an exploded upper perspective view of the present invention.

FIG. 3 is a sectional view of the present invention.

FIG. 4 is a view of the present invention in use.

FIG. 5 is a view of the present invention in use with the pressure relief valve in a remote location.

### DETAILED DESCRIPTION OF THE INVENTION

### A. Overview

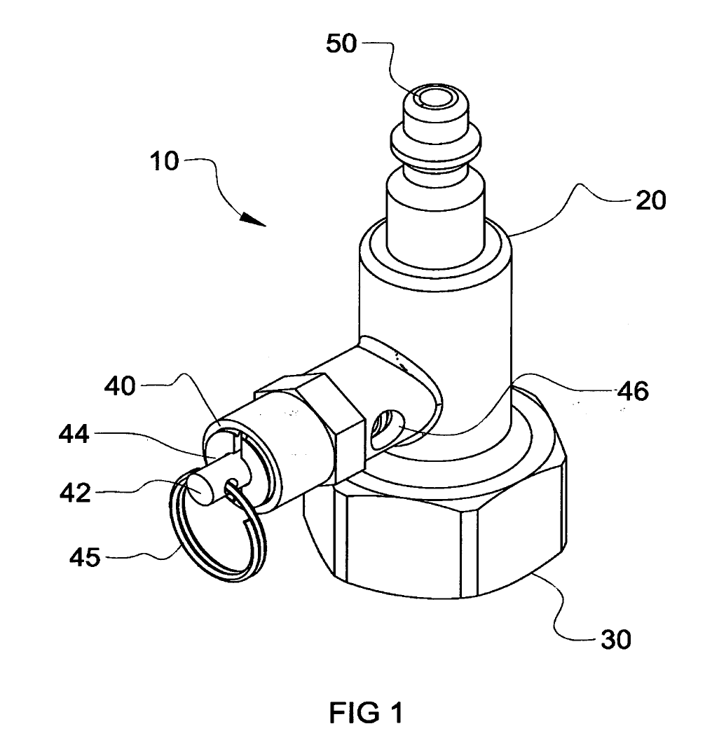

Turning now descriptively to the drawings, in which similar reference characteristics denote similar elements throughout the several views, FIGS. 1 through 5 illustrate the purge/inject safety mechanical apparatus 10, which comprises a base member 20, including a system connection opening 30, safety relief valve opening 40, and fluid/gas purge/inject opening 50. Connection opening 30 has industry standard female-iron-pipe threads that can be adapted to as needed. Safety relief valve opening 40 is machine on the inside to provide the necessary features to accommodate the safety valve parts. Fluid/gas purge/inject opening 50 is machined on the outside with an industry standard air hose quick release geometry, and on the inside to house a one-way-flow check valve.

### B. Base Member

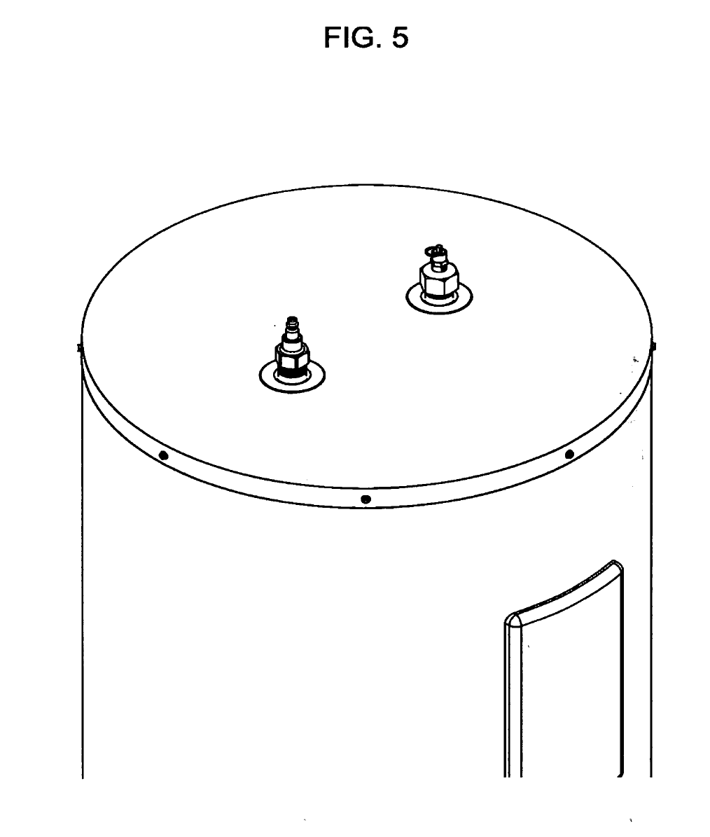

Base member 20 is preferably comprised of a one-piece cast brass, that receives machining for parts 31, 34, 41, 42, 43, & 44; however, an alternate two-part base embodiment is illustrated in FIG. 5. Materials other than brass may be used to construct base member 20 and its alternate design.

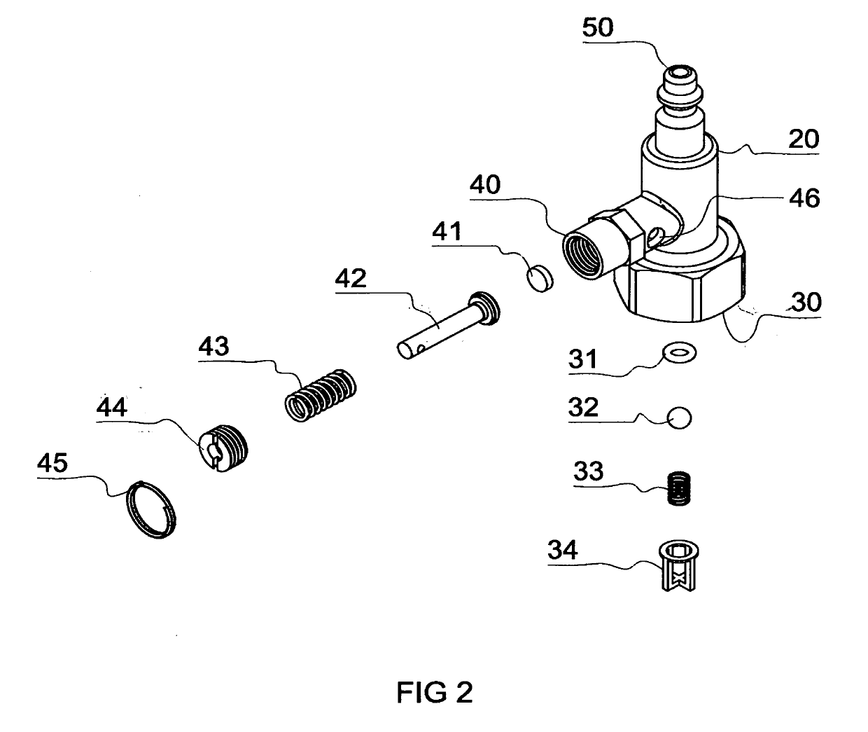

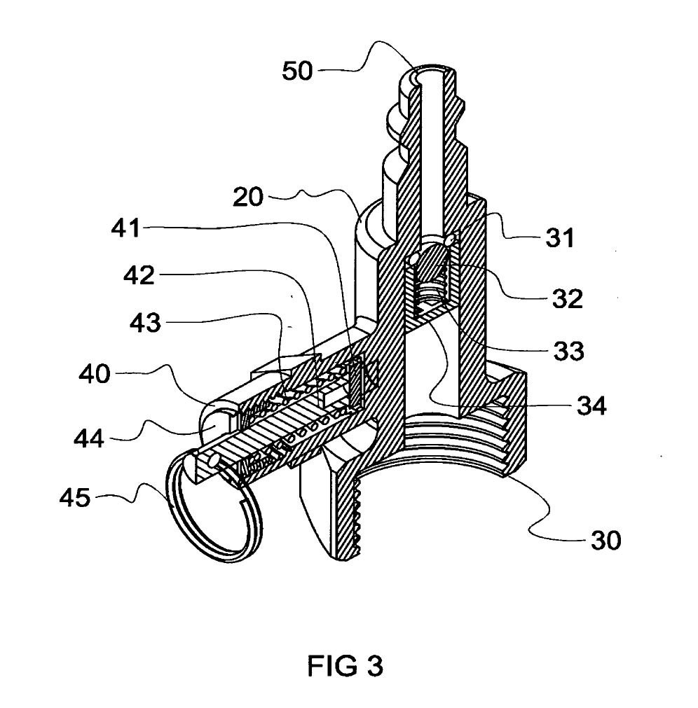

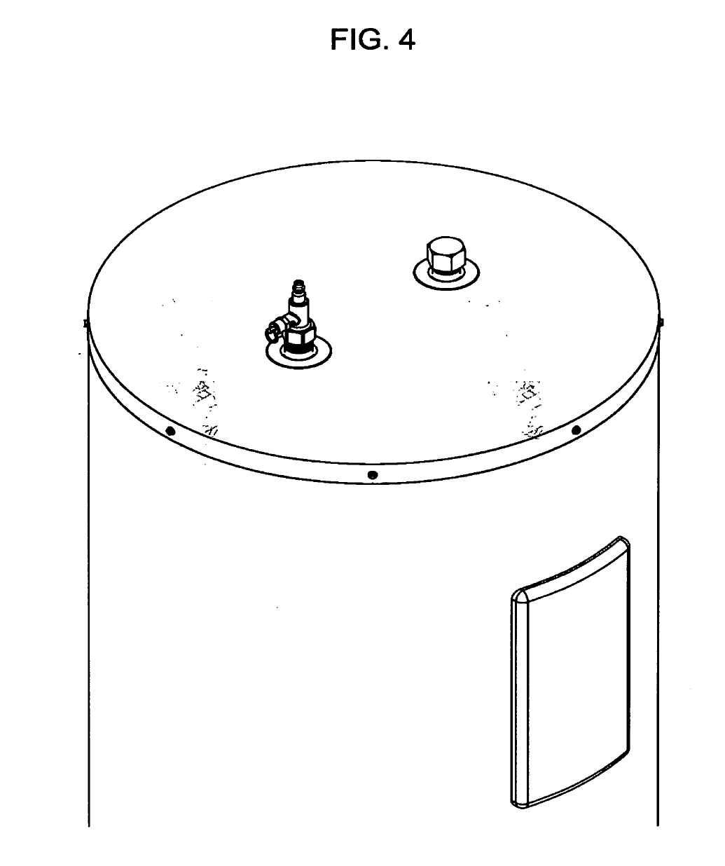

Base member 20 also preferably includes two pressure relief holes 46 as shown in FIG. 1, FIG. 2, FIG. 4, & FIG.5, a hexagon shape at opening 30 as shown in FIGS. 1 through 5, and industry standard female-iron-pipe threads at opening 30 as shown in FIG. 3.

It is appreciated that the preferred construction of base member 20 does not need to be limited to a machined casting but can be comprised of a plurality of parts as an alternate embodiment. FIG. 4 shows the invention as a one-piece preferred embodiment, and FIG. 5 depicts it as an alternate two-piece embodiment.

### C. Check Valve Member

The check valve member is preferably comprised of parts 31, 32, 33, & 34 as shown in FIGS. 2 & 3, and is preferably lightly pressed as a subassembly into a machined cavity in base member 20. O-ring 31 preferably creates an airtight seal between base member 20 and ball bearing 32. Ball bearing 32 is preferably kept in position by spring 33, and check valve housing 34 preferably retains all other parts.

It is appreciated that alternate embodiments of internal and external check valves can serve the preferred function of not permitting two-way flow at purge/inject opening 50.

### D. Pressure Relief Member

The pressure relief member 40 is preferably the housing for parts 41, 42, 43, & 44. Washer 41 preferably rests against a preferably machine seat in base member 20. Washer 41 is preferably cradled in a preferable bonnet at the end of valve stem 42. Stem 42 is preferably forced towards the machine seat in base member 20. Spring 43 preferably supplies the adjustable pressure to top of the bonnet on valve stem 42. Adjustment plug 44 preferably compresses spring 43 to various pressures depending on how much it compresses the spring 43. It is preferable that the greater compression of spring 43 results in a needed higher pressure within a mechanical system to open the pressure relief member 40.

Pressure relief member 40 also preferably utilizes relief holes 46 in the event the relief valve opens due to excess pressure.

It is appreciated that alternate embodiments of pressure relief valves can serve the preferred function of releasing excess pressure within a mechanical system.

### E. Fluid/Gas Purge/Inject Member 50

Fluid/gas purge/inject member 50 is preferably machined into base member 20, and it has the industry standard geometry that exist on quick release connections on a typical air hose.

It is appreciated that the preferred industry standard geometry can have several alternate embodiments.
What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A purge/inject fluid/gas mechanical apparatus, comprising: a base member with a port that attaches to a mechanical system, purge/inject inlet connection, and a pressure relief valve; wherein said inlet connection is accompanied by a plurality of parts that make up a one-way flow apparatus typically know as a check valve; wherein said pressure relief valve is adjustable to open at different pressures, whether factory set, or field adjusted.

2. The purge/inject fluid/gas mechanical apparatus of claim 1, comprising of two base members that connect at different locations of a mechanical system; wherein said base member one is comprised of the said purge/inject inlet with said plurality of parts making up a check valve, and a said port for connection to a mechanical system; wherein, said base member two is comprised of a said pressure relief valve, and a said port for connection to a mechanical system.

3. The purge/inject fluid/gas mechanical apparatus of claim 1 and alternate purge/inject fluid/gas mechanical apparatus of claim 2, comprising of a plurality of general plumbing fittings that make-up a said connection to a mechanical system with a said purge/inject connection with said check valve and a said pressure relief valve; wherein said plurality fitting made-up configurations can either be in the spirit and scope of said claim 1 being one apparatus, or the spirit or scope of said claim 2 with being two apparatuses.
